(19) United States
(12) Patent Application Publication
(10) Pub. No.: US 2016/0364754 A1
(43) Pub. Date: Dec. 15, 2016

(54) PERSONALIZED MARKETING BY DERIVING THE SENTIMENTS FROM TELEPHONIC AND TEXTUAL CONVERSATION OVER A MOBILE DEVICE

(71) Applicant: International Business Machines Corporation, Armonk, NY (US)

(72) Inventors: Sandip P. Thube, Pune (IN); Dattatraya R. Ubhe, Pune (IN); Dharmesh V. Vadgama, Pune (IN)

(21) Appl. No.: 14/737,396

(22) Filed: Jun. 11, 2015

(51) Int. Cl. G06Q 30/02; G10L 25/48; G06F 17/27; G10L 15/07; G06N 99/00; G06N 5/04

(52) U.S. Cl. CPC G06Q 30/0255; G06N 99/005; G06N 5/04; G06F 17/2775; G10L 15/075; G10L 25/48

(57) ABSTRACT

A method for creating a personalized marketing strategy for a user involved in an online conversation associated with a mobile device is provided. The method may include receiving a strategy and execution plan. The method may also include receiving a plurality of searchable keywords. The method may include monitoring the online conversation to identify the presence of the searchable keywords. The method may also include capturing a plurality of statements containing the searchable keywords. The method may include deriving a plurality of sentiments and a plurality of psychographics from the captured plurality of statements. The method may include mapping the derived plurality of sentiments and the derived plurality of psychographics to a plurality of segments associated with the received strategy and execution plan. The method may also include creating a marketing strategy and a personalized offer associated with the user based on the mapping.

### BACKGROUND

The present invention relates generally to the field of computers, and more particularly to online communication systems.

Typically, a marketer wants to understand the current as well as the planned activities of customers so that they may provide more specific and relevant offers to the customers. Similarly, the marketer may want to capture sentiments of the customer so that may provide more specific and relevant offers to them. For example, customer communication data, such as events or emotions may aide a marketer in servicing their clients. Currently, manual intervention by the customer is required for the marketer to gain access to such customer communication data.

### SUMMARY

According to one embodiment, a method for creating a personalized marketing strategy for a user involved in an online conversation associated with a mobile device is provided. The method may include receiving a strategy and execution plan. The method may also include receiving a plurality of searchable keywords. The method may further include monitoring the online conversation associated with the mobile device to identify the presence of the received plurality of searchable keywords. The method may also include capturing a plurality of statements containing the identified plurality of searchable keywords. The method may include deriving a plurality of sentiments and a plurality of psychographics from the captured plurality of statements. The method may additionally include mapping the derived plurality of sentiments and the derived plurality of psychographics to a plurality of segments associated with the received strategy and execution plan. The method may also include creating a marketing strategy and a personalized offer associated with the user based on the mapping.

According to another embodiment, a computer system for creating a personalized marketing strategy for a user involved in an online conversation associated with a mobile device is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a strategy and execution plan. The method may also include receiving a plurality of searchable keywords. The method may further include monitoring the online conversation associated with the mobile device to identify the presence of the received plurality of searchable keywords. The method may also include capturing a plurality of statements containing the identified plurality of searchable keywords. The method may include deriving a plurality of sentiments and a plurality of psychographics from the captured plurality of statements. The method may additionally include mapping the derived plurality of sentiments and the derived plurality of psychographics to a plurality of segments associated with the received strategy and execution plan. The method may also include creating a marketing strategy and a personalized offer associated with the user based on the mapping.

According to yet another embodiment, a computer program product for creating a personalized marketing strategy for a user involved in an online conversation associated with a mobile device is provided. The computer program product may include one or more computer-readable storage devices and program instructions stored on at least one of the one or more tangible storage devices, the program instructions executable by a processor. The computer program product may include program instructions to receive a strategy and execution plan. The computer program product may also include program instructions to receive a plurality of searchable keywords. The computer program product may further include program instructions to monitor the online conversation associated with the mobile device to identify the presence of the received plurality of searchable keywords. The computer program product may also include program instructions to capture a plurality of statements containing the identified plurality of searchable keywords. The computer program product may include program instructions to derive a plurality of sentiments and a plurality of psychographics from the captured plurality of statements. The computer program product may additionally include program instructions to map the derived plurality of sentiments and the derived plurality of psychographics to a plurality of segments associated with the received strategy and execution plan. The computer program product may also include program instructions to create a marketing strategy and a personalized offer associated with the user based on the mapping.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program that personalizes marketing by deriving sentiments from telephonic and textual conversation over a mobile device according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to online communication systems. The following described exemplary embodiments provide a system, method and program product to, among other things, capture customer sentiments (i.e., keywords or tokens preconfigured by a customer or marketer) by analyzing conversations (i.e., audio, textual or both) on a mobile device, such as a smart phone. Therefore, the present embodiment has the capacity to improve the technical field of online communication systems with respect to marketing by learning the sentiments of a customer. More specifically, the present embodiment may aide in making a marketer aware of the sentiments of a customer by using psychographics (i.e., the study of personality, values, opinions, attitudes, interests, and lifestyles) associated with the customer to map a developed marketing strategy and execution. As such, the present embodiment may aide a marketer in deriving offers from psychographics of a customer and as a result, be able to promote these offers to the customers which may improve customer satisfaction levels and relations with a brand to gain an increase in return on marketing investment (ROMI).

As previously described, a marketer usually wants to understand the current as well as the planned activities of his customers so that they may provide more specific and relevant offers to them. Similarly, the marketer may want to capture sentiments of the customer so that may provide more specific and relevant offers to them. For example, customer communication data, such as events or emotions may aide a marketer in servicing their clients.

However, there is no system available to capture sentiments of customers derived from a conversation (audio, textual, or both) on a mobile device and detect events that may be important to the customers and use such captured and detected information for personalized marketing pertaining to the needs and interests of the customer. Currently, manual intervention by the customer may be required for the marketer to gain access to such customer communication data. For example, manual intervention, such as social posts and emails by the customer may need to be relied on in order for the marketer to obtain and utilize pertinent customer information that may aide in the marketer better servicing the customer.

As such, it may be advantageous, among other things, to improve marketing execution by capturing communication data over a conversation (audio, text, or both) associated with a mobile device, whereby the captured communication data may be used as a prime source of information and to analyze the sentiment of a customer, such as experiences, plans, likes and dislikes, pain points, their views about specific products, upcoming events, etc.

According to at least one implementation, the present embodiment may personalize marketing by developing marketing strategy and execution based on psychographics derived from the sentiments of a customer captured through audio and textual conversations over a computer or a mobile device, such as a smart phone which are received or sent via SMS, a mobile application, or an internet browser, for example. As such, the present embodiment may be implemented as a mobile application with predefined and/or custom tags (e.g., movies, travel, shopping, etc.) that can capture the context of an audio or text message conversation. Then, sentiment analysis may be performed using existing technology, such as SPSS® (IBM® SPSS® and all IBM® SPSS®-based trademarks and logos are trademarks IBM® Corporation or registered trademarks of IBM® and/or its affiliates), IBM® Social Media Analytics® (IBM® Social Media Analytics® and all IBM® Social Media Analytics®-based trademarks and logos are trademarks or registered trademarks of IBM® Corporation and/or its affiliates), or IBM® Watson Solutions® (IBM® Watson Solutions® and all IBM® Watson Solutions®-based trademarks and logos are trademarks or registered trademarks of IBM® Corporation and/or its affiliates). Additional current technology, such as IBM® Enterprise Marketing Management (EMM), may be used to interact and develop a marketing strategy and execution plan. Thus, the generated offer may then be delivered using an online communication system, such as an online messaging service.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to provide the capability to selectively collect sentimental data from a conversation (i.e., audio, text, or both) associated with a mobile device (e.g., a smartphone) based on predefined tokens (predefined by the application user or marketer) that are installed on the mobile device. As such, the present embodiment (e.g., implemented as a mobile application) may send the collected data to a marketing decision engine (i.e., an analytic search engine on an analytic server) to identify the sentiment and deliver an offer based on the marketing strategy. Additionally, according to the present embodiment, the confidentiality of the user's communication may not be compromised, as the user may have options to provide selective tokens and also to enable or disable the present embodiment (i.e., the mobile application) on their mobile device, such as a smart phone based on a predefined criteria (e.g., contact groups, time etc.)

According to at least one implementation, the present embodiment may be implemented as an application on a mobile device, such as a smartphone and a marketer may develop a strategy and execution plan for different type of sentiments and psychographics. Then, a customer (i.e., a user) may configure keywords, such as “movie”, “shopping”, “cosmetic”, “travelling”, etc. on the installed application on the mobile device. As such, the present embodiment may begin monitoring audio and text conversations occurring on the phone. Next, keywords may be captured from the conversation (e.g., “shopping” or “movie”). Then, statements containing these keywords are sent to an analytic server for processing. The analytic server may then derive sentiments and psychographics (using existing technology) of the customer and map the sentiments and psychographics with segments for decision making (by using existing technology) and execute a marketing strategy and offer personalization for the customer so that the offer may then be delivered to the customer. Once the customer either accepts or rejects the offer, responses may be tracked and populated to be used as learning for prediction.

The present embodiment provides a mobile device (e.g., smart phone) application base approach for near real-time marketing offer delivery, whereby personalized marketing can be offered by deriving the sentiments from telephonic and textual conversations over mobile devices, such as smart phones. The present embodiment not only uses keywords for specific brands but also to capture events or items from the conversations for near real-time analysis to identify marketing opportunities and relevant as well as personalized offer deliveries. As such, the present embodiment may analyze a conversation between a user using the mobile application and any other person.

According to at least one implementation, a token based approach may be utilized. As such, a user controlled mechanism may be implemented through which a user of the mobile application may specify his/her explicit interest. Additionally, a user may have proper control over the conversation being monitored since the user may selectively turn on and off the data capturing from the user's communication over mobile devices for selective contacts or conversation. Therefore, the user may be able to control a data flow from the mobile device to a marketer or analytical server.

The present embodiment provides a token based approach to selectively capture predefined token sentences and send them to analytical server for further processing or sentiment derivation. As such, the communication data between a mobile device and analytical server may be decreased. Additionally, sentiment analysis is done on analytical server and therefore, the mobile device may not be overloaded with this processing of sentiment derivation. More specifically, according to the present embodiment, the capturing of only required sentences (customer specified interest for receiving offer) is happening on the mobile device while the sentiment analytics, marketing decision, and offer execution is handled at the server level resulting in an intelligent way of performing personalized marketing by developing marketing strategy and execution based on psychographics derived from the sentiments of customer captured through telephonic and textual conversations over mobile devices. As such, the present embodiment may save processing and unnecessary execution of a marketing offer and may ultimately result in a high return on marketing investments if response rate is high and retains a customer's interest.

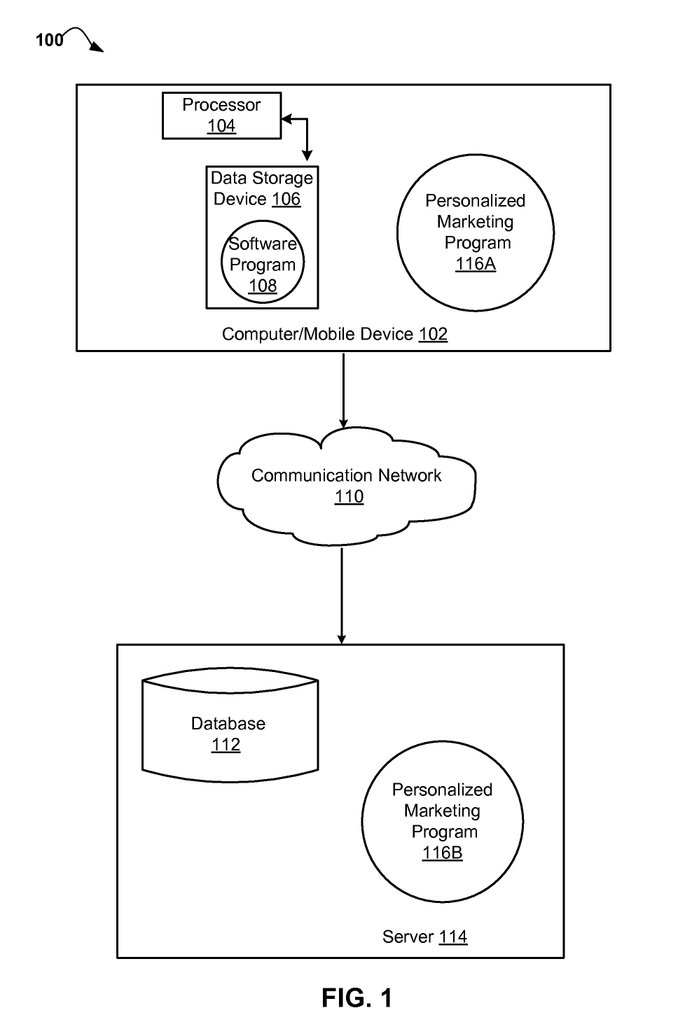

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a Personalized Marketing Program 116A. The networked computer environment 100 may also include a server 114 (i.e., an analytic server) that is enabled to run a Personalized Marketing Program 116B that may interact with a database 112 and a communication network 110. The networked computer environment 100 may include a plurality of computer 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

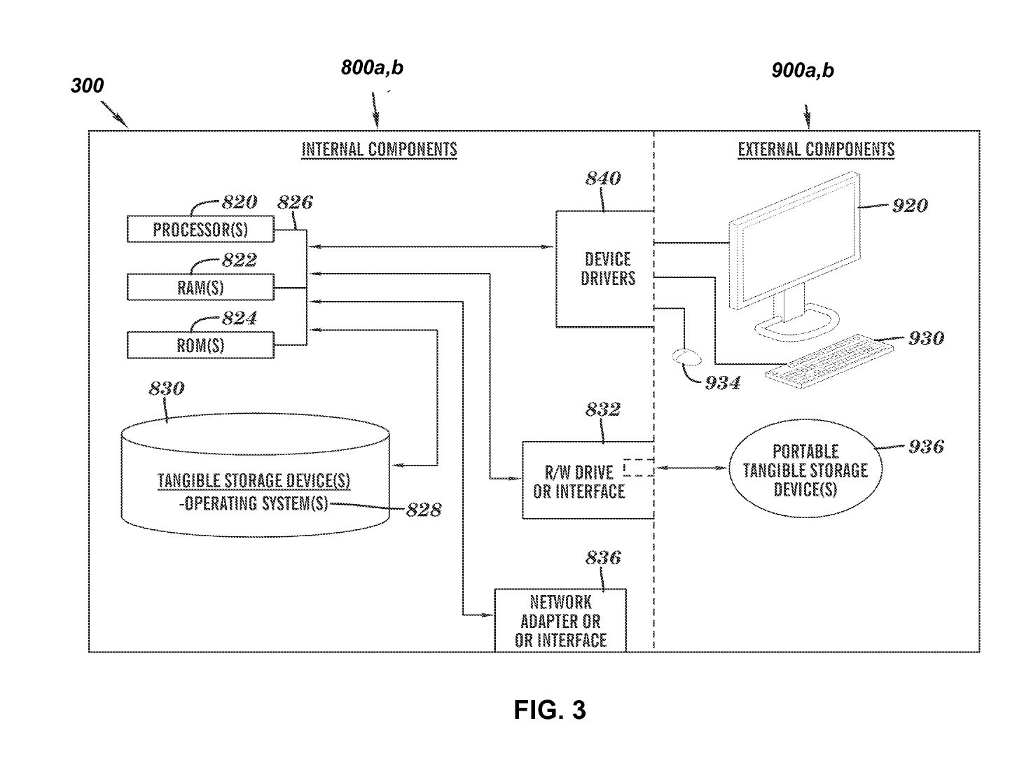

The client computer 102 may communicate with the Personalized Marketing Program 116B running on server computer 114 via the communications network 110. The communications network 110 may include connections, such as wire, wireless communication links, or fiber optic cables. As will be discussed with reference to FIG. 3, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database 112. According to various implementations of the present embodiment, the Personalized Marketing Program 116A, 116B may interact with a database 112 that may be embedded in various storage devices, such as, but not limited to a computer/mobile device 102, a networked server 114, or a cloud storage service.

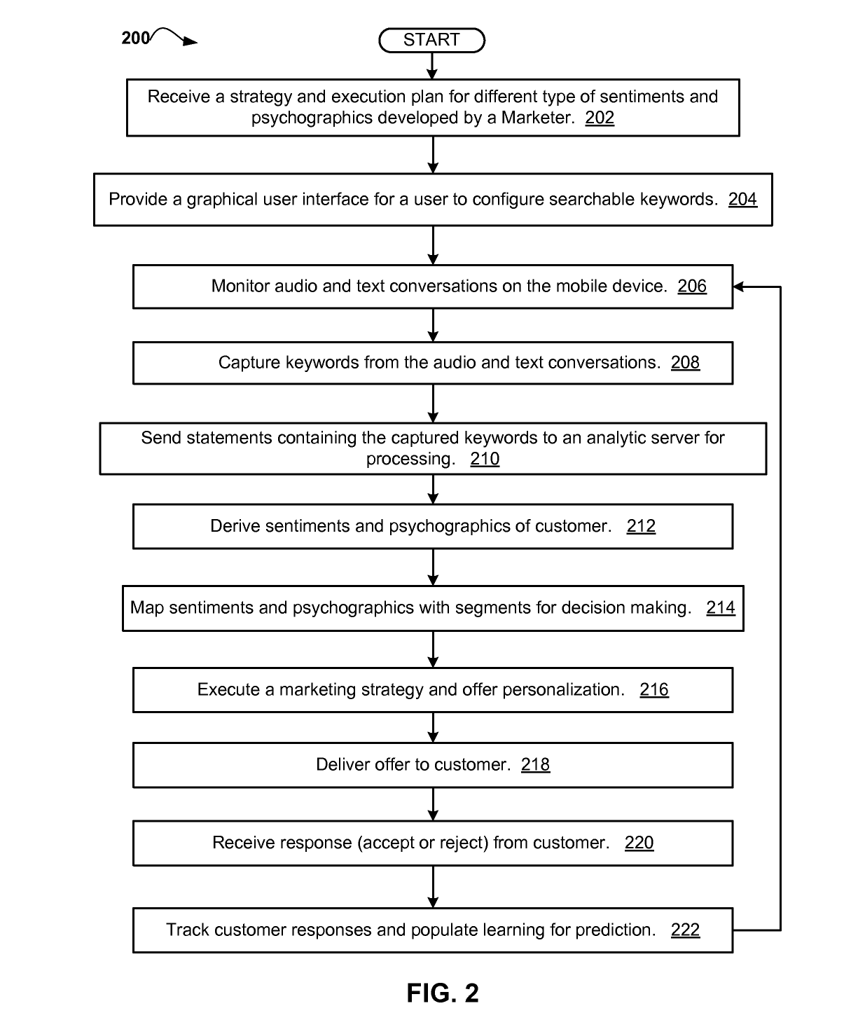

As previously described, the client computer 102 may access the Personalized Marketing Program 116B, running on server computer 114 via the communications network 110. For example, a marketer may utilize the Personalized Marketing Program 116A, 116B to personalize marketing for a customer using a client computer 102 (i.e., a mobile device) by monitoring and deriving sentiments from telephonic and textual conversation of the customer over the mobile device 102. According to at least one implementation, pre-configured keywords may be captured from the customer's conversation(s) and sent to the analytic server 114 for processing. Then, the analytic server 114 may derive (using existing technology) sentiments and psychographics of the customer and map the derived sentiments and psychographics with the marketers segments (from a pre-developed strategy and execution plan for different types of sentiments and psychographics by the marketer) for execution of a personalized marketing strategy and offer. The Personalized Marketing method is explained in more detail below with respect to FIG. 2.

Referring now to FIG. 2, an operational flowchart 200 illustrating the steps carried out by a program that personalizes marketing by deriving sentiments from telephonic and textual conversation over a mobile device is depicted. As previously described, the Personalized Marketing Program 116A, 116B (FIG. 1) may personalize marketing by deriving the sentiments from a telephonic and textual conversation over a mobile device 102 (FIG. 1). According to at least one implementation, the present embodiment may be implemented as a mobile application or a software program 116A, 116B (FIG. 1) associated with a mobile device 102 (FIG. 1), such as a smartphone. The present embodiment may selectively collect sentimental data from a conversation (audio, text, or both) based on a predefined token (i.e., preconfigured keywords) by an application user of the present embodiment or marketer using the present embodiment which is installed on the mobile device 102 (FIG. 1), such as the smart phone. Therefore, the present embodiment (which may be implemented as the mobile application or software program) sends the collected data to a marketing decision engine (i.e., an analytics server 114 (FIG. 1)) to identify the sentiment and deliver a correct offer based on the marketing strategy. The confidentiality of the user's communication will not be compromised, as user may have options to provide selective tokens and also to enable or disable the present embodiment on his smart phone 102 (FIG. 1) based on predefined criteria, such as contact groups, time, etc.

Therefore with respect to FIG. 2 at 202, the Personalized Marketing Program 116A, 116B (FIG. 1) receives a strategy and execution plan for different type of sentiments and psychographics developed by a marketer. Such marketing strategies and execution plans may be implemented using existing technology, such as IBM® Campaign® (IBM® Campaign® and all IBM® Campaign®-based trademarks and logos are trademarks or registered trademarks of IBM® Corporation and/or its affiliates), IBM® Interact® (IBM® Interact® and all IBM® Interact®-based trademarks and logos are trademarks or registered trademarks of IBM® Corporation and/or its affiliates), and IBM® Social Media Analytics®.

Then at 204, the Personalized Marketing Program 116A, 116B (FIG. 1) provides a user interface on a mobile device or a computer 102 (FIG. 1) for a user (i.e., a customer or a marketer) to configure searchable keywords. For example, a customer may configure keywords, such as “movie”, “shopping”, “cosmetic”, “travelling”, etc. on the developed smartphone application (i.e., the Personalized Marketing Program 116A, 116B (FIG. 1)).

Next at 206, the Personalized Marketing Program 116A, 116B (FIG. 1) monitors audio and text conversations of the customer on the mobile device. As such, the present embodiment may begin monitoring audio and text conversations occurring on the mobile device in order to identify the preconfigured keywords from the conversation (e.g., “shopping” or “movie”).

Then at 208, the Personalized Marketing Program 116A, 116B (FIG. 1) captures keywords (and the statements that contain the keywords) from the audio and text conversations. As such, sentiments (i.e., keywords and tokens that have been preconfigured by the customer or marketer), such as “shopping” or “movie” are captured by the present embodiment.

Next at 210, the Personalized Marketing Program 116A, 116B (FIG. 1) sends the statements containing the captured keywords to an analytic server for processing. Therefore, the Personalized Marketing Program 116A, 116B (FIG. 1) sends the statements containing the captured keywords, such as “shopping” or “movie” to an analytic server, such as server 114 (FIG. 1) for processing of the statements and keywords.

Then at 212, the Personalized Marketing Program 116A, 116B (FIG. 1) derives sentiments and psychographics of the customer from the captured keywords. As previously explained, psychographics is the study of personality, values, opinions, attitudes, interests, and lifestyles. According to at least one implementation, the present embodiment may derive psychographics and sentiments (e.g., opinions and attitudes) about the customer from the keywords that were captured based on the tokens and keywords that were preconfigured by the customer and marketer. Such psychographics and sentiments may be derived using existing technology, such as IBM® SPSS®, IBM® Watson®, or IBM® Social Media Analytics®.

Next at 214, the Personalized Marketing Program 116A, 116B (FIG. 1) maps the sentiments and psychographics with segments for decision making. Therefore, the Personalized Marketing Program 116A, 116B (FIG. 1), running on the analytic server 114 (FIG. 1) may map (using existing technology, such as IBM® Campaign®) the derived sentiments and psychographics with the marketers segments (i.e., pre-developed strategies and execution plans for different types of sentiments and psychographics) for execution of a personalized marketing strategy and offer.

Then at 216, the Personalized Marketing Program 116A, 116B (FIG. 1) executes a marketing strategy and offers personalization based on the mapping. According to at least one implementation, the present embodiment may utilize existing technology, such as IBM® Interact® and IBM® Campaign® to execute a marketing strategy and a personalized offer pertaining to the customer.

Next at 218, the Personalized Marketing Program 116A, 116B (FIG. 1) delivers an offer to the customer. According to at least one implementation, the present embodiment may utilize existing technology, such as IBM® Interact®, IBM® eMessage® (IBM® eMessage® and all IBM® eMessage®-based trademarks and logos are trademarks or registered trademarks of IBM® Corporation and/or its affiliates), and IBM® Xtify® (IBM® Xtify® and all IBM® Xtify®-based trademarks and logos are trademarks or registered trademarks of IBM® Corporation and/or its affiliates) to deliver the personalized offer (based on the created marketing strategy) to the customer.

Then at 220, the Personalized Marketing Program 116A, 116B (FIG. 1) receives a response (acceptance or rejection) to the offer from the customer. According to the present embodiment, the customer may be prompted via a graphical user interface to respond to the offer with either an acceptance or rejection of the proposed offer.

Next at 222, the Personalized Marketing Program 116A, 116B (FIG. 1) tracks customer responses and populates learning for prediction. According to at least one implementation, the present embodiment may utilize existing technology, such as IBM® Interact®, IBM eMessage®, IBM® Xtify®, and IBM® SPSS® to track (and store in a database 112 (FIG. 1)) the acceptance and rejection responses from the customer to populate learning for prediction to be used in future marketing analysis.

Then, the method will continue back to previously described step 206 to continue to monitor audio and text conversations on the mobile device.

An example of a use case may be as follows:

Customer A is in agreement with service provider for uses of the present embodiment implemented as an application on their mobile device. As such, the present embodiment is already installed on Customer A's smart phone. Customer A calls a friend casually to know about whereabouts. The part of their conversation is mentioned below:

Customer A: Hey, what are you planning for coming Weekend?

Customer B: Nothing special, will be at home, let me know if you guys are planning anything which we can join.

Customer A: I am planning to watch Movie—NNN, which is really cool I heard from my friends and a bit of shopping if I get a better deal on clothes at Phoenix Market City.

Customer B: Great, We also would like to join for Movie and shopping

Telephonic conversation ends here.

The present embodiment may work as described below for the above conversation:
Customer A is interested in the offers related to Shopping, Movies, Cosmetic etc. so they have configured the Application (i.e., the present embodiment) on their cell to process audio and text conversations related to these topics.
From above conversation the Application running on Customer A's phone captures the keywords mentioned in bold as these are the words configured to process in the Application's configuration.
As such, these statements (including a few Pre and Post words) of the captured keywords or tokens are sent to the analytics Server machine for analysis purpose.
The analytical server analyzes these statements to understand the customer sentiments.
The captured keywords suggest that Customer A is planning a movie and shopping on the coming weekend.
Therefore, the present embodiment may identify an offer for particular mall where multiplex is available along with better shopping options. Also, the present embodiment may check Customer A's shopping history and based on that history it may find Customer A's preferred shopping location and identify the right offer.
The designed offer may then be delivered to Customer A on the preferred channel. By default it may be delivered on the same application running on the customer's smart phone.
Therefore, Customer A may be pleased to receive an offer which is more relevant to Customer A's future plan which Customer A can actually redeem.

Advantages of the present embodiment may include an automated way of capturing customer sentiments by analyzing the mobile device conversations (audio or textual or both); by learning the sentiments of customer, a marketer may be aware of psychographics of customers which may play key role in mapping with developed marketing strategy and execution; and deriving offers from psychographics of customers and promoting these offers to customers may improve customer satisfaction levels and relations with a brand, which may ultimately result in an increase in return on marketing investment (ROMI).

It may be appreciated that FIG. 2 provides only an illustration of one implementation and does not imply any limitations with regard to how different embodiments may be implemented. Many modifications to the depicted environments may be made based on design and implementation requirements. For example, as previously described, the present embodiment may be implemented with an option to have an enabling or disabling feature which includes disabling the application from running on the mobile device or to configure the enabling or disabling feature to selectively enable the application for a particular set of contacts. For example, a user may want to enable this feature to a group of friends from the user's contact list with whom the user speaks with more socially. However, the user may not want to enable the application for business partners or colleagues. As such, the present embodiment enables a customer to be allowed to selectively enable or disable a specific contact's conversation from his contact list to get analyzed.

Additionally, the present embodiment may capture and analyze the online conversation between two parties and distinguish the host (i.e., the customer's mobile device where the application portion of the present embodiment is installed) and other side of the communication party (i.e., the other party involved in the conversation with the customer). As such, the present embodiment can utilize the two-way data (i.e., conversation) for analysis purposes so as to come up with a better marketing strategy for a marketer since the marketer may have an idea about the customer friend's sentiment as well. Therefore, the marketer can derive a marketing strategy based on the combination of a customer and the customer's friends' or relatives' sentiments. Thus, the offer derivation may be implemented for the customer (i.e., host) and not for the other party. Furthermore, as previously described, the present embodiment may be implemented on any mobile device/computer 102 (FIG. 1), such as a smartphone.

The present embodiment uses real-time audio and text analysis sentiments for real-time marketing as well as proposing a personalized marketing for a customer. As such, the present embodiment provides a real-time personalized marketing (execution of marketing strategy) driven through sentiments derived from audio and textual conversations over smart phones by listening and analyzing conversations of customers over a mobile device, such as a smartphone and as a result, providing an intelligent way of reaching out to customers. As such, the audio and textual conversations become input to marketing strategies and decisions by marketers.

Additionally, the present embodiment may be implemented as an application-based solution which may provide more flexibility to consumers who may want to configure keywords, approve sentiments etc. Also, the processing (capturing keywords and identifying statements containing configured keywords) may be done on client devices which may provide more control to end-users and more confidence to customers due to their privacy being controlled on device. According to at least one implementation, the present embodiment installed as an application on the mobile device may also offer a delivery channel, notifying customers for the same, and as such, may become a primary channel for contacting customers.

According to various implementations, the captured data by the present embodiment may also be utilized by marketers to intelligently offer to convert negative sentiments into superior brand experience and utilize positive sentiments for cross sell or up-sell opportunities. Additionally, the present embodiment may also be implemented as a plug-in to other applications, such as banking applications, etc.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800 a,b and external components 900 a,b illustrated in FIG. 3. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) and the Personalized Marketing Program 116A (FIG. 1) in client computer 102 (FIG. 1) and the Personalized Marketing Program 116B (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Personalized Marketing Program 116A, 116B (FIG. 1) can be stored on one or more of the respective portable computer-readable tangible storage devices 936, read via the respective R/W drive or interface 832 and loaded into the respective hard drive 830.

Each set of internal components 800 a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) and the Personalized Marketing Program 116A (FIG. 1) in client computer 102 (FIG. 1) and the Personalized Marketing Program 116B (FIG. 1) in network server 114 (FIG. 1) can be downloaded to client computer 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) and the Personalized Marketing Program 116A (FIG. 1) in client computer 102 (FIG. 1) and the Personalized Marketing Program 116B (FIG. 1) in network server 114 (FIG. 1) are loaded into the respective hard drive 830. The network may comprise copper wires, optical fibers, wireless transmission, routers, firewalls, switches, gateway computers and/or edge servers.

Each of the sets of external components 900 a,b can include a computer display monitor 920, a keyboard 930, and a computer mouse 934. External components 900 a,b can also include touch screens, virtual keyboards, touch pads, pointing devices, and other human interface devices. Each of the sets of internal components 800 a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

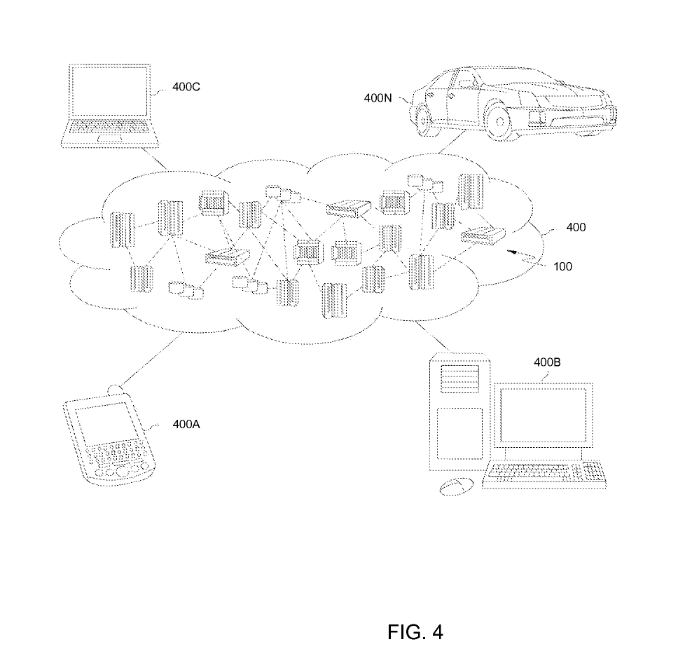

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

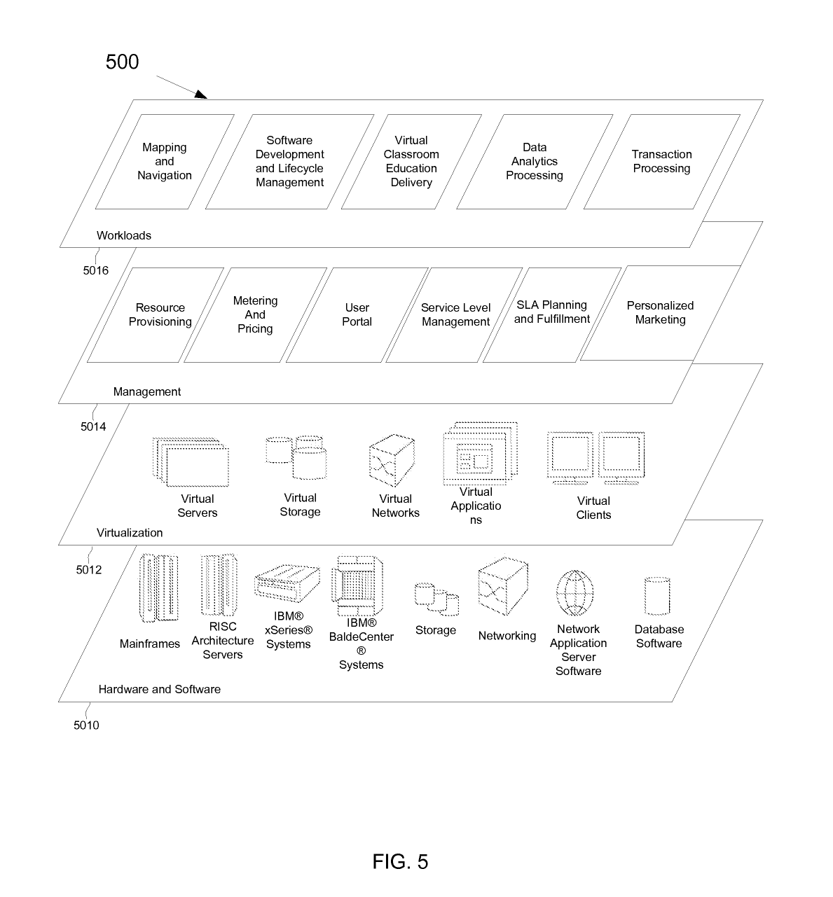

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 5010 includes hardware and software components. Examples of hardware components include: mainframes; RISC (Reduced Instruction Set Computer) architecture based servers; storage devices; networks and networking components. In some embodiments, software components include network application server software.

Virtualization layer 5012 provides an abstraction layer from which the following examples of virtual entities may be provided: virtual servers; virtual storage; virtual networks, including virtual private networks; virtual applications and operating systems; and virtual clients.

In one example, management layer 5014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A Personalized Marketing Program may personalize marketing by deriving sentiments from telephonic and textual conversation of a customer over a mobile device.

Workloads layer 5016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for creating a personalized marketing strategy for a user involved in an online conversation associated with a mobile device, the method comprising:
receiving a strategy and execution plan;
receiving a plurality of searchable keywords;
monitoring the online conversation associated with the mobile device to identify the presence of the received plurality of searchable keywords;
capturing a plurality of statements containing the identified plurality of searchable keywords;
deriving a plurality of sentiments and a plurality of psychographics from the captured plurality of statements;
mapping the derived plurality of sentiments and the derived plurality of psychographics to a plurality of segments associated with the received strategy and execution plan; and
creating a marketing strategy and a personalized offer associated with the user based on the mapping.

2. The method of claim 1 further comprising:
delivering the personalized offer to the user;
receiving a response from the user;
tracking the response from the user; and
populating a learning repository for prediction based on the tracked response.

3. The method of claim 1, wherein the online conversation comprises an audio conversation, a textual conversation, or a combination of an audio and textual conversation.

4. The method of claim 1, wherein the received plurality of keywords are configured by the user or a marketer.

5. The method of claim 2, wherein the received response from the user is either an acceptance of the delivered personalized offer or a rejection of delivered personalized offer.

6. The method of claim 1, wherein the captured plurality of statements containing the identified plurality of searchable keywords are sent to a marketing search engine.

7. The method of claim 6, wherein the marketing search engine derives the plurality of sentiments and the plurality of psychographics from the captured plurality of statements and maps the derived plurality of sentiments and the derived plurality of psychographics to the plurality of segments associated with the received strategy and execution plan.

8. A computer system for a user involved in an online conversation associated with a mobile device, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving a strategy and execution plan;
receiving a plurality of searchable keywords;
monitoring the online conversation associated with the mobile device to identify the presence of the received plurality of searchable keywords;
capturing a plurality of statements containing the identified plurality of searchable keywords;
deriving a plurality of sentiments and a plurality of psychographics from the captured plurality of statements;
mapping the derived plurality of sentiments and the derived plurality of psychographics to a plurality of segments associated with the received strategy and execution plan; and
creating a marketing strategy and a personalized offer associated with the user based on the mapping.

9. The computer system of claim 8 further comprising:
delivering the personalized offer to the user;
receiving a response from the user;
tracking the response from the user; and
populating a learning repository for prediction based on the tracked response.

10. The computer system of claim 8, wherein the online conversation comprises an audio conversation, a textual conversation, or a combination of an audio and textual conversation.

11. The computer system of claim 8, wherein the received plurality of keywords are configured by the user or a marketer.

12. The computer system of claim 9, wherein the received response from the user is either an acceptance of the delivered personalized offer or a rejection of delivered personalized offer.

13. The computer system of claim 8, wherein the captured plurality of statements containing the identified plurality of searchable keywords are sent to a marketing search engine.

14. The computer system of claim 13, wherein the marketing search engine derives the plurality of sentiments and the plurality of psychographics from the captured plurality of statements and maps the derived plurality of sentiments and the derived plurality of psychographics to the plurality of segments associated with the received strategy and execution plan.

15. A computer program product for a user involved in an online conversation associated with a mobile device, the computer program product comprising:
one or more computer-readable storage devices and program instructions stored on at least one of the one or more tangible storage devices, the program instructions executable by a processor, the program instructions comprising:
program instructions to receive a strategy and execution plan;
program instructions to receive a plurality of searchable keywords;
program instructions to monitor the online conversation associated with the mobile device to identify the presence of the receive plurality of searchable keywords;
program instructions to capture a plurality of statements containing the identified plurality of searchable keywords;
program instructions to derive a plurality of sentiments and a plurality of psychographics from the captured plurality of statements;
program instructions to map the derived plurality of sentiments and the derived plurality of psychographics to a plurality of segments associated with the received strategy and execution plan; and
program instructions to create a marketing strategy and a personalized offer associated with the user based on the mapping.

16. The computer program product of claim 15 further comprising:
program instructions to deliver the personalized offer to the user;
program instructions to receive a response from the user;
program instructions to track the response from the user; and
program instructions to populate a learning repository for prediction based on the tracked response.

17. The computer program product of claim 15, wherein the online conversation comprises an audio conversation, a textual conversation, or a combination of an audio and textual conversation.

18. The computer program product of claim 15, wherein the received plurality of keywords are configured by the user or a marketer.

19. The computer program product of claim 16, wherein the received response from the user is either an acceptance of the delivered personalized offer or a rejection of delivered personalized offer.

20. The computer program product of claim 15, wherein the captured plurality of statements containing the identified plurality of searchable keywords are sent to a marketing search engine.
